(19) United States
(12) Patent Application Publication
(10) Pub. No.: US 2014/0223084 A1
(43) Pub. Date: Aug. 7, 2014

(54) MEMORY SYSTEM AND RELATED METHOD OF OPERATION

(71) Applicant: Samsung Electronics Co., Ltd., Suwon-si (KR)

(72) Inventors: JIN-HYUK LEE, SEOUL (KR); YEONG-JAE WOO, SUWON-SI (KR)

(73) Assignee: SAMSUNG ELECTRONICS CO., LTD., SUWON-SI (KR)

(21) Appl. No.: 14/155,570

(22) Filed: Jan. 15, 2014

(30) Foreign Application Priority Data
Feb. 6, 2013 (KR) 10-2013-0013506

(51) Int. Cl. G06F 12/02

(52) U.S. Cl. CPC G06F 12/0246; G06F 12/0253
USPC 711/103

(57) ABSTRACT

A method of operating a memory system comprises determining whether a write request from a host is a random write request, and as a consequence of determining that the write request is a random write request, programming a lower page of a selected word line of a nonvolatile memory device with restorable data of the nonvolatile memory device, and programming an upper page of the selected word line with write data corresponding to the write request after programming the lower page.

### CROSS-REFERENCE TO RELATED APPLICATIONS

This application claims priority under 35 U.S.C. §119 to Korean Patent Application No. 10-2013-0013506 filed on Feb. 6, 2013, the subject matter of which is hereby incorporated by reference.

### BACKGROUND OF THE INVENTION

The inventive concept relates generally to memory systems comprising nonvolatile memory devices and related methods of operation.

Semiconductor memories play an important role in most computers and other microprocessor-based applications ranging from satellites to consumer electronics. Consequently, advances in the design and fabrication of semiconductor memories can have a significant impact on the performance of a wide array of technologies.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power. Examples of volatile memory devices include dynamic random access memory (DRAM) and static random access memory (SRAM). Examples of nonvolatile memories include Mask Read-Only Memory (MROM), Programmable Read-Only Memory (PROM), Erasable Programmable Read-Only Memory (EPROM), and Electrically Erasable Programmable Read-Only Memory (EEPROM).

Certain types of nonvolatile memory devices, such as flash memory devices, have practical limits on the number of times they can programmed or erased before losing reliability or failing. These limits can be referred to generally as the program or erase endurance of a device. In consideration of these limits, researchers are continually seeking ways to improve the lifetime of devices, either by increasing the program or erase endurance of devices or by developing techniques to avoid unnecessary program or erase operations.

### SUMMARY OF THE INVENTION

In one embodiment of the inventive concept, a method of operating a memory system comprises determining whether a write request from a host is a random write request, and as a consequence of determining that the write request is a random write request, programming a lower page of a selected word line of a nonvolatile memory device with restorable data of the nonvolatile memory device, and programming an upper page of the selected word line with write data corresponding to the write request after programming the lower page.

In another embodiment of the inventive concept, a memory system comprises a nonvolatile memory device comprising multiple memory blocks, and a memory controller configured to control the nonvolatile memory device, wherein the controller is configured to receive a write request from a host, determine whether the write request is a random write request, and as a consequence of determining that the write request is a random write request, programming a lower page of a selected word line of the nonvolatile memory device with restorable data of the nonvolatile memory device, and programming an upper page of the selected word line with write data corresponding to the write request after programming the lower page.

In yet another embodiment of the inventive concept, a method of operating a memory system comprising a nonvolatile memory device comprises storing a first unit of data at a first location in the nonvolatile memory device, and thereafter receiving a write request to program a second unit of data at a second location in the nonvolatile memory device, determining whether the write request is a sequential write request, and as a consequence of determining that the write request is not a sequential write request, programming the first unit of data in a lower page of the second location without erasing the first unit of data from the first location, and initiating programming of the second unit of data in an upper page of the second location.

These and other embodiments of the inventive concept can potentially improve the performance and lifetime of a memory system by skipping an LSB page backup operation and programming restorable data in an LSB page and user data in an MSB page.

### BRIEF DESCRIPTION OF THE DRAWINGS

The drawings illustrate selected embodiments of the inventive concept. In the drawings, like reference numbers indicate like features.

FIG. 1 is a block diagram illustrating a memory system according to an embodiment of the inventive concept.

FIG. 2 is a block diagram illustrating a memory controller in FIG. 1 according to an embodiment of the inventive concept.

FIG. 3 is a block diagram illustrating a nonvolatile memory device in FIG. 1 according to an embodiment of the inventive concept.

FIG. 4 is a flowchart illustrating a method of programming a memory system according to an embodiment of the inventive concept.

FIG. 5 is a diagram illustrating a data flow for a random write request of FIG. 4 according to an embodiment of the inventive concept.

FIG. 6 is a diagram illustrating a program failure or power-off operation occurring during an MSB program operation of a memory system according to an embodiment of the inventive concept.

FIG. 7 is a flowchart illustrating a method of programming a memory system according to another embodiment of the inventive concept.

FIG. 8 is a block diagram illustrating a computing system according to an embodiment of the inventive concept.

FIG. 9 is a block diagram illustrating a solid state drive (SSD) according to an embodiment of the inventive concept.

FIG. 10 is a block diagram illustrating a storage system comprising the SSD of FIG. 9 according to an embodiment of the inventive concept.

FIG. 11 is a block diagram illustrating a storage server comprising the SSD of FIG. 9 according to an embodiment of the inventive concept.

FIG. 12 is a block diagram illustrating a moviNAND according to an embodiment of the inventive concept.

FIG. 13 is a block diagram illustrating a communication device according to an embodiment of the inventive concept.

FIG. 14 is a diagram illustrating systems comprising a data storage device according to various embodiments of the inventive concept.

FIG. 15 is a block diagram illustrating a memory card according to an embodiment of the inventive concept.

FIG. 16 is a block diagram illustrating a digital camera according to an embodiment of the inventive concept.

FIG. 17 is a diagram illustrating various systems comprising the memory card of FIG. 15 according to embodiments of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “first”, “second”, “third”, etc., may be used to describe various features, but the described features should not be limited by these terms. Rather, these terms are used merely to distinguish between different features. Thus, a first feature discussed below could be termed a second feature without departing from the teachings of the inventive concept.

The terminology used herein is for the purpose of describing embodiments only and is not intended to be limiting of the inventive concept. As used herein, the singular forms “a”, “an” and “the” are intended to include the plural forms as well, unless the context clearly indicates otherwise. Terms such as “comprises” and/or “comprising,” where used in this specification, indicate the presence of stated features but do not preclude the presence or addition of one or more other features. As used herein, the term “and/or” includes any and all combinations of one or more of the associated listed items. Where a feature is referred to as being “on”, “connected to”, “coupled to”, or “adjacent to” another feature, it can be directly on, connected, coupled, or adjacent to the other feature, or intervening features may be present.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present specification and should not be interpreted in an idealized or overly formal sense unless expressly so defined herein.

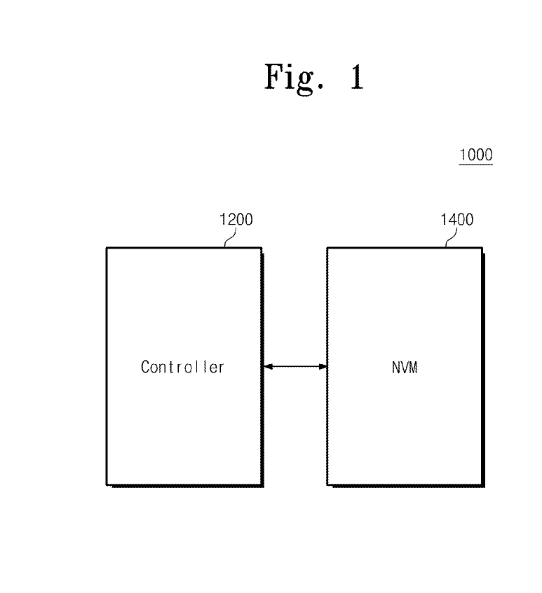

FIG. 1 is a block diagram illustrating a memory system 1000 according to an embodiment of the inventive concept.

Referring to FIG. 1, a memory system 1000 comprises a memory controller 1200 and a nonvolatile memory device 1400.

Nonvolatile memory device 1400 is a multi-bit memory device, i.e., it comprises multi level cells (MLCs). Memory controller 1200 is configured to control nonvolatile memory device 1400 in response to a request from an external source. Such a request may be, for instance, a read, write, or erase request from a host. Memory controller 1200 is also configured to control nonvolatile memory device 1400 without a request from an external device, e.g., in a power-off operation, a wear-leveling operation, or a read reclaim operation. Such operations may be executed during a timeout period of a host or after a host request is processed. Alternatively, such operations may be executed during an idle time of memory controller 1200.

Nonvolatile memory device 1400 operates under control of memory controller 1200, and it comprises a storage medium comprising one or more memory chips. Nonvolatile memory device 1400 communicates with memory controller 1200 via one or more channels. Nonvolatile memory device 1400 may comprise a NAND flash memory device, for example.

Where nonvolatile memory device 1400 is a memory device storing 2-bit data in each cell, 2-page data (hereinafter, “LSB page data” and “MSB page data”) may be stored in memory cells connected with the same word line. In such a device, where power is turned off during an MSB page program operation of nonvolatile memory device 1400 or an MSB page program failure is generated, LSB page data may be changed. For this reason, it is necessary to back up LSB page data to a separate storage space before an MSB page program operation of nonvolatile memory device 1400 is performed. Accordingly, the MSB page program operation may comprise operations of reading LSB page data, programming the read LSB page data in a separate storage space, and programming MSB page data. These operations may deteriorate the performance and lifetime of nonvolatile memory device 1400 due to the additional read and program operations of the LSB page data.

To avoid this deterioration, memory controller 1200 controls nonvolatile memory device 1400 such that restorable data is programmed in an LSB page and write data received from a host is programmed in an MSB page. As used herein, the term “restorable data” denotes data that is already stored in another location of nonvolatile memory device 1400 when the LSB page is programmed and can therefore be restored in the event that the LSB page data is lost. Examples of restorable data include garbage collection data or meta data. As used herein, the term “garbage collection data” denotes valid data stored at a memory block that is a target of a garbage collection operation. Valid data stored in such a memory block may remain valid until garbage collection is performed.

Because restorable data is programmed in the LSB page, even if power is unexpectedly turned off when programming MSB page data, or programming of MSB page data fails, data programmed in the LSB page may be recovered. This also avoids a need to separately store LSB page data in prior to programming MSB page data.

In some embodiments, memory controller 1200 and nonvolatile memory device 1400 may form a multi-media card (MMC) or an embedded MMC (eMMC) mounted on a board of a handheld electronic device.

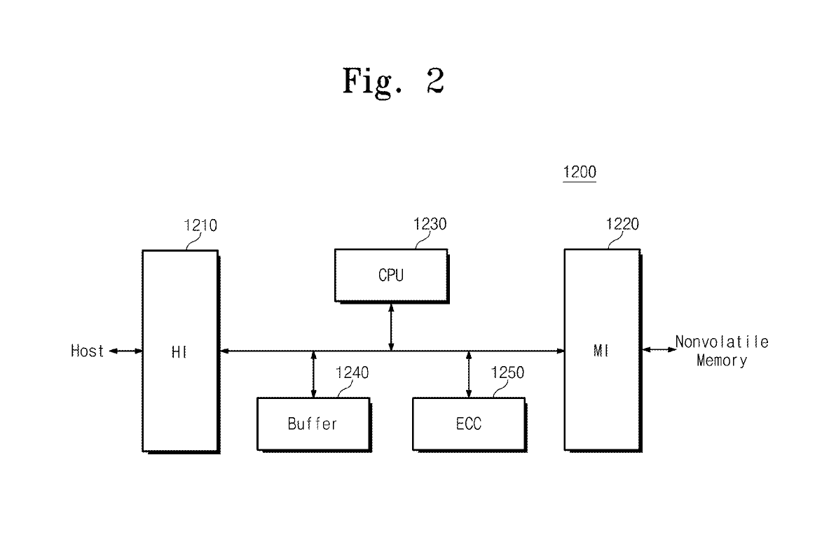

FIG. 2 is a block diagram illustrating memory controller 1200 of FIG. 1 according to an embodiment of the inventive concept.

Referring to FIG. 2, memory controller 1200 comprises a host interface 1210 as a first interface, a memory interface 1220 as a second interface, a CPU 1230, a buffer memory 1240, and an error detecting and correcting circuit (ECC) 1250.

Host interface 1210 is configured to interface with an external device (e.g., a host), and memory interface 1220 is configured to interface with nonvolatile memory device 1400. CPU 1230 is configured to control operations of controller 1200. CPU 1230 may be configured to operate firmware such as Flash Translation Layer (FTL), for example. The FTL may perform a variety of functions. For example, the FTL may comprise a variety of layers performing an address mapping operation, a read reclaim operation, an error correction operation, and so on.

CPU 1230, or an FTL managed by CPU 1230, determines whether a write request of a host is a random write request or a sequential write request. Where the write request of the host is a sequential write request, CPU 1230 or the FTL managed by CPU 1230 controls nonvolatile memory device 1400 such that data write requested by a host is sequentially programmed in LSB and MSB pages. In this case, a last page data may be copied to a separate storage space according to whether first page data of the write data affects the last page data previously written. This will be more fully described later. Where the write request of the host is the random write request, CPU 1230 or the FTL managed by CPU 1230 controls nonvolatile memory device 1400 such that restorable LSB page data is programmed prior to programming of the write data. That is, where the write request of the host is the random write request, CPU 1230 or the FTL managed by CPU 1230 may control nonvolatile memory device 1400 such that restorable data is programmed in an LSB page and the write data is programmed in an MSB page. This will be more fully described later.

In some embodiments, whether a write request of the host is a random write request may be determined based on a size of the write data, although the inventive concept is not limited thereto.

Buffer memory 1240 is used to temporarily store data to be transferred from an external device via host interface 1210 or data to be transferred from nonvolatile memory device 1400 via memory interface 1220. Buffer memory 1240 is used to store information (e.g., address mapping information, etc.) used to control nonvolatile memory device 1400. Buffer memory 1240 may be formed of DRAM, SRAM, or a combination of DRAM and SRAM. However, the inventive concept is not limited thereto. ECC 1250 may be configured to encode data to be stored in nonvolatile memory device 1400 and to decode data read out from nonvolatile memory device 1400.

Although not illustrated in figures, memory controller 1200 may further comprise a randomizer/de-randomizer configured to randomize data to be stored in nonvolatile memory device 1400 and to de-randomize data read from nonvolatile memory device 1400. An example of the randomizer/de-randomizer is disclosed in U.S. Patent Publication No. 2010/0088574, the subject matter of which is hereby incorporated by reference.

In some embodiments, host interface 1210 implements one or more computer bus standards, storage bus standards, and/or iFCPPeripheral bus standards. Examples of computer bus standards include S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, and the like. Examples of storage bus standards include ST-506, ESDI, SMD, Parallel ATA, DMA, SSA, HIPPI, USB MSC, FireWire(1394), Serial ATA, eSATA, SCSI, Parallel SCSI, Serial Attached SCSI, Fibre Channel, iSCSI, SAS, RapidlO, FCIP, etc. Examples of iFCPPeripheral bus standards include Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, and the like.

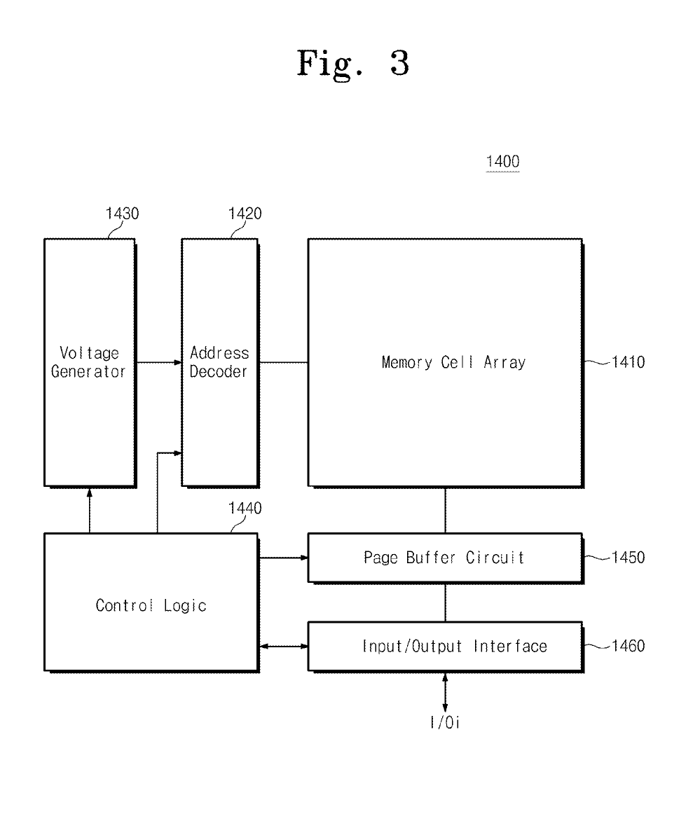

FIG. 3 is a block diagram illustrating nonvolatile memory device 1400 of FIG. 1 according to an embodiment of the inventive concept. As indicated above, nonvolatile memory device 1400 may be a NAND flash memory device, for example, although it is not limited thereto. For example, it could alternatively be a NOR flash memory device, a Resistive Random Access Memory (RRAM) device, a Phase-Change Memory (PRAM) device, a Magnetroresistive Random Access Memory (MRAM) device, a Ferroelectric Random Access Memory (FRAM) device, a Spin Transfer Torque Random Access Memory (STT-RAM), and the like. Further, nonvolatile memory device 1400 may be implemented with a three-dimensional array structure. A nonvolatile memory device having the three-dimensional array structure may be referred to as a vertical NAND flash memory device. The inventive concept may also be applied to a Charge Trap Flash (CTF) memory device comprising a charge storage layer formed of an insulation film as well as a flash memory device comprising a charge storage layer formed of a conductive floating gate.

Referring to FIG. 3, nonvolatile memory device 1400 comprises a memory cell array 1410, an address decoder 1420, a voltage generator 1430, control logic 1440, a page buffer circuit 1450, and an input/output interface 1460.

Memory cell array 1410 comprises memory cells arranged at intersections of rows (e.g., word lines) and columns (e.g., bit lines). Each memory cell may store 1-bit data or M-bit data as multi-bit data (M>1). Address decoder 1420 is controlled by control logic 1440, and it performs selecting and driving operations on rows (e.g., word lines, a string selection line(s), a ground selection line(s), a common source line, etc.) of memory cell array 1410. Voltage generator 1430 is controlled by control logic 1440, and it generates voltages required for various operations. Such voltages may include, e.g., a high voltage, a program voltage, a read voltage, a verification voltage, an erase voltage, a pass voltage, a bulk voltage, and the like. Voltages generated by voltage generator 1430 may be provided to memory cell array 1410 via address decoder 1420. Control logic 1440 controls operations of nonvolatile memory device 1400.

Page buffer circuit 1450 is controlled by control logic 1440 and is configured to read data from memory cell array 1410 and to drive columns (e.g., bit lines) of memory cell array 1410 according to program data. Page buffer circuit 1450 comprises page buffers respectively corresponding to bit lines or bit line pairs. Each of the page buffers typically comprises multiple latches.

Input/output interface 1460 is controlled by control logic 1440, and it interfaces with an external device (e.g., a memory controller in FIG. 2). Although not illustrated in FIG. 3, input/output interface 1460 may comprise a column decoder configured to select page buffers of page buffer circuit 1450 by a predetermined unit, an input buffer receiving data, an output buffer outputting data, and so on.

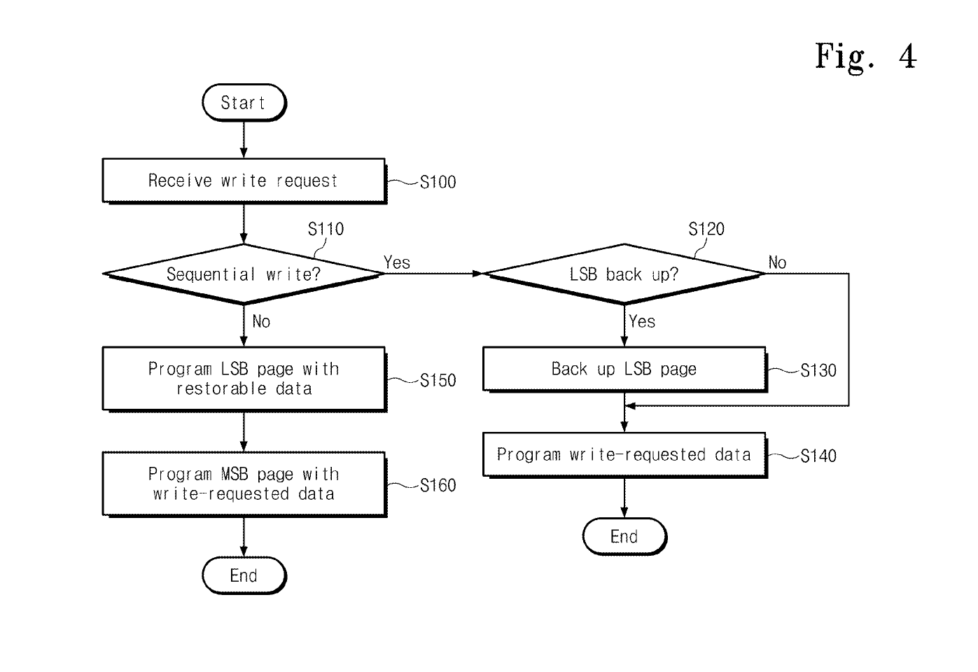

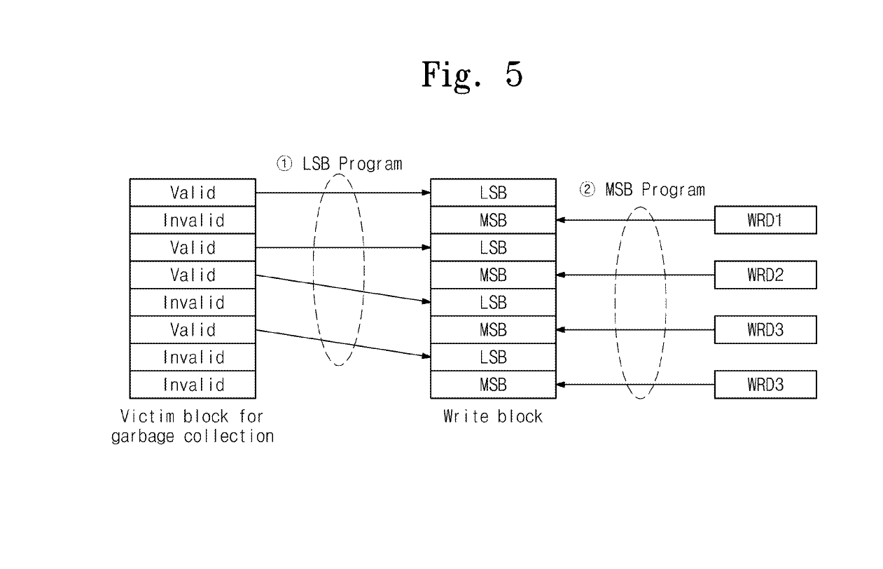

FIG. 4 is a flowchart illustrating a method of programming a memory system according to an embodiment of the inventive concept. FIG. 5 is a diagram illustrating a data flow for a random write request of FIG. 4 according to an embodiment of the inventive concept. For convenience, the method of FIG. 4 will be described with reference to memory system 1000 as described above, although the method is not limited to being performed by this or any other specific system.

Referring to FIG. 4, in operation S100, memory system 1000 receives a write request from a host. In operation S110, memory controller 1200 determines whether the write request of the host is a sequential write request. If the write request of the host is a sequential write request (S110=Yes), the method proceeds to operation S120, in which memory controller 1200 determines whether a copy of an LSB page is required. For example, memory controller 1200 may determine whether first page data of currently write data is MSB page. This may mean that the last page data of previously written data is LSB page data. Where MSB page data is programmed without copying of LSB page data, the LSB page data may be damaged in a program failure of MSB page data or by a loss of power (“power-off”) generated during an MSB page program operation.

Where first page data of data input at the sequential write request is MSB page data (S120=Yes), the method proceeds to operation S130. In operation S130, LSB page data of a storage space where first page data of data input at the sequential write request is to be programmed is copied to a separate storage space of nonvolatile memory device 1400. Afterwards, the method proceeds to operation S140. Returning to operation S120, if first page data of data input at the sequential write request is LSB page data (S120=No), the method may proceed to operation S140. In operation S140, data write requested by the host, that is, sequential write data may be sequentially programmed at nonvolatile memory device 1400 under a control of memory controller 1200. Afterwards, the method ends.

Returning to operation S110, if the write request of the host is not the sequential write request (S110=No), that is, the write request of the host is the random write request, the method proceeds to operation S150. In operation S150, memory controller 1200 controls nonvolatile memory device 1400 such that restorable data is programmed in an LSB page. For example, referring to FIG. 5, where the write request of the host is not the random write request, first, memory controller 1200 may select a memory block (hereinafter, a “victim block”) being a garbage collection target and memory block (hereinafter, a “write block”) where write data is to be stored. Then, memory controller 1200 controls nonvolatile memory device 1400 such that valid page data of the victim block is programmed in an LSB page of the write block (\textcircled{1}). Here, LSB page data copied from the victim block may be restorable data. That is, valid data stored at the victim block being a garbage collection target may be validly maintained before the victim block is erased.

After valid page data of the victim block is programmed in an LSB page of the write block, the method proceeds to operation S160. In operation S160, memory controller 1200 controls nonvolatile memory device 1400 such that the write data is programmed in an MSB page. For example, referring to FIG. 5, memory controller 1200 may control nonvolatile memory device 1400 such that the write data is programmed as MSB page data in a storage space of the write block where valid page data of the victim block is programmed (\textcircled{2}). Afterwards, the method ends.

In the embodiments described with reference to FIGS. 4 and 5, LSB data programmed in the write block and copied from the victim block is recovered from the victim block upon program failure or loss of power in an MSB page program operation. Thus, a backup operation on an LSB page may be skipped in an MSB page data program operation. In some embodiments, where a random write operation is requested, valid data of the victim block may be programmed at the write block as LSB page data, and write data may be programmed as MSB page data at a storage space where valid data of the victim block is programmed in an LSB page. In some embodiments, where the last valid data of the victim is copied, the victim block may be erased after MSB page data as write data is programmed at a storage space where the last valid data of the victim block is programmed.

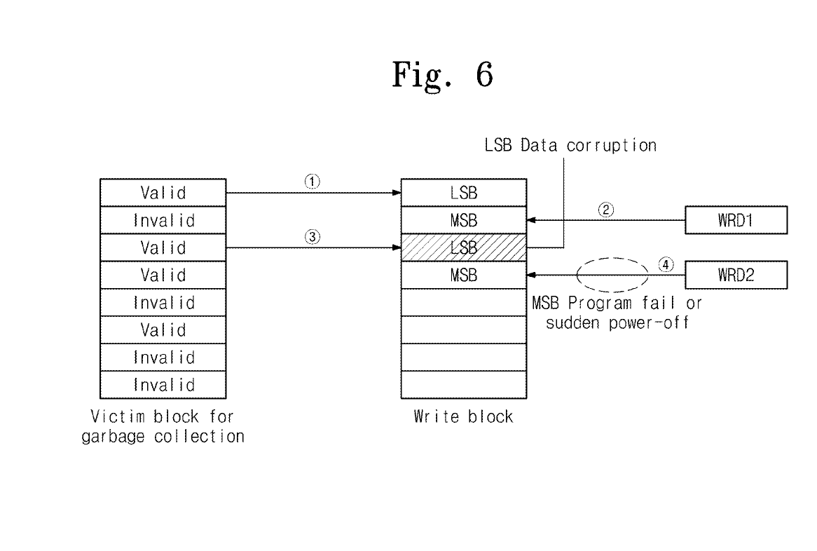

FIG. 6 is a diagram illustrating a program failure or power-off operation occurring during an MSB program operation of a memory system according to an embodiment of the inventive concept.

Referring to FIG. 6, where a write request of a host is a random write request, first valid data of a victim block may be programmed in an LSB page of a write block (\textcircled{1}). Then, write data WRD1 is programmed as MSB page data in a storage space where the valid data of the victim block is programmed in an LSB page (\textcircled{2}). The above-described operations may be repeated where a random write operation is requested. For example, where write data WRD2 of the host is random write data, valid data of the victim block is programmed in an LSB page of the write block (\textcircled{3}). Then, write data WRD2 is programmed as MSB page data in a storage space where the valid data of the victim block is programmed in an LSB page (\textcircled{4}). If power-off occurs in a program operation on write data WRD2 or program fail on write data WRD2 is generated, LSB page data may be changed/damaged. However, because LSB page data changed/damaged is stored at the victim block, it may be recovered from the victim block.

In some embodiments, metadata of memory controller 1200 can be used as LSB page data at a random write request instead of valid data of the victim block. In some embodiments, valid data of the victim block is stored in a write block through a read operation and a program operation. At this time, valid data read from the victim block may be provided to memory controller 1200, and memory controller 1200 may perform an error correction operation on the read data, and error corrected data may be provided to a nonvolatile memory device 1400. The error corrected data provided to nonvolatile memory device 1400 may be stored at a write block as LSB page data. Also, valid data read from the victim block may be stored at the write block though read and program operations of nonvolatile memory device 1400 without an error correction operation of memory controller 1200.

In some embodiments, where a write request of a host is a random write request and a victim block does not exist due to frequent overwriting, random write data may be programmed in an LSB page or an MSB page. At this time, if the random write data is written at the MSB page, previously written LSB page data may be copied to a separate storage space of nonvolatile memory device 1400. After the previously written LSB page data is copied to the separate storage space of nonvolatile memory device 1400, an MSB page program operation may be performed.

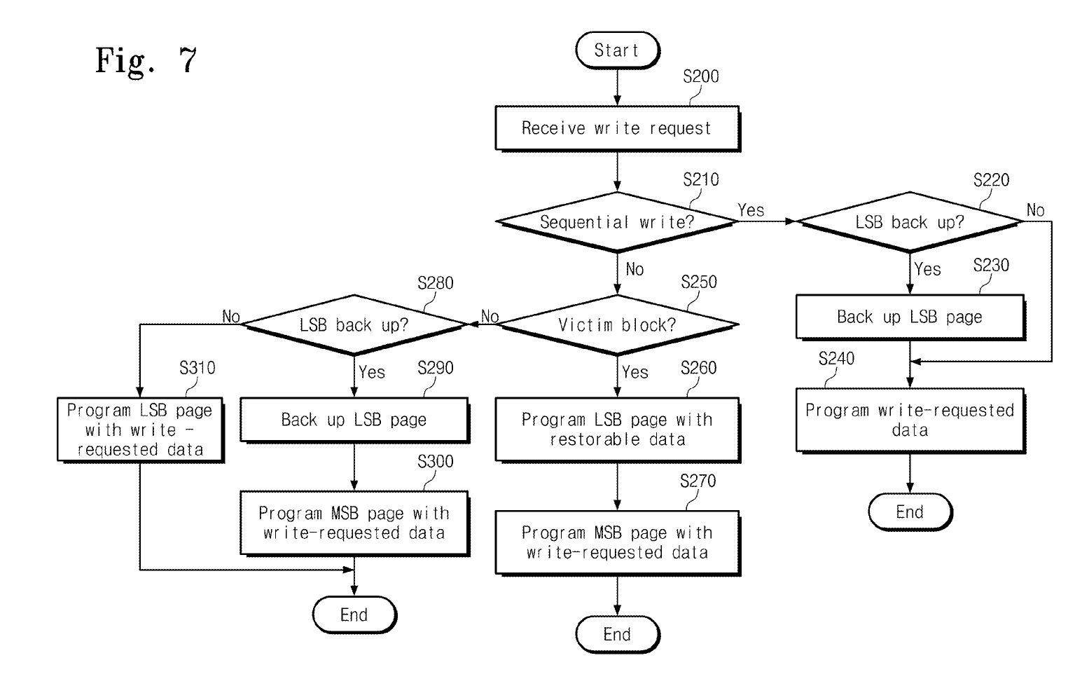

FIG. 7 is a flowchart illustrating a method of programming a memory system according to another embodiment of the inventive concept. For convenience, the method of FIG. 7 will be described with reference to memory system 1000 as described above, although the method is not limited to being performed by this or any other specific system.

Referring to FIG. 7, in operation S200, memory system 1000 receives a write request from a host. In operation S210, memory controller 1200 determines whether the write request is a sequential write request. If the write request is a sequential write request (S210=Yes), the method proceeds to operation S220, in which memory controller 1200 determines whether a copy of an LSB page is required. For example, memory controller 1200 may determine whether first page data of currently write data is an MSB page. This may mean that the last page data of previously written data is LSB page data. Where MSB page data is programmed without copying of LSB page data, the LSB page data may be damaged at program fail of MSB page data or by power-off generated in an MSB page program operation.

Where first page data of data input at the sequential write request is MSB page data (5220=Yes), the method proceeds to operation S230. In operation S130, LSB page data of a storage space where first page data of data input at the sequential write request is to be programmed is copied to a separate storage space of nonvolatile memory device 1400. Afterwards, the method proceeds to operation S240. Returning to operation S220, if first page data of data input at the sequential write request is LSB page data (S220=No), the method proceeds to operation S240. In operation S240, data write requested by the host, that is, sequential write data is sequentially programmed at nonvolatile memory device 1400 under a control of memory controller 1200. Afterwards, the method ends.

Returning to operation S210, if the write request of the host is not the sequential write request (S210=No), that is, the write request of the host is the random write request, the method proceeds to operation S250. In operation S250, memory controller 1200 determines whether a victim block exists. As described above, where an overwrite operation is frequently generated due to a working characteristic, the victim block may not exist. In this case (S250=No), the method proceeds to operation S280. Otherwise, if the victim block exists (S250=Yes), the method proceeds to operation S260. In operation S260, memory controller 1200 controls nonvolatile memory device 1400 such that restorable data is programmed in an LSB page. This may be performed as described with reference to FIGS. 4 and 5, and a description thereof is thus omitted.

After valid page data of the victim block is programmed in an LSB page of the write block, the method proceeds to operation S270. In operation S270, memory controller 1200 controls nonvolatile memory device 1400 such that the write data is programmed in an MSB page. This may be performed as described with reference to FIGS. 4 and 5, and a description thereof is thus omitted. Afterwards, the method ends.

In operation S280, memory controller 1200 determines whether a copy of an LSB page is required. If a copy of an LSB page is required, the method proceeds to operation S290. In operation S290, under the control of memory controller 1200, LSB page data of a storage space where data input at the random write request is to be programmed is copied to a separate storage space of a nonvolatile memory device 1400. In operation S300, data write requested by the host, that is, random write data is programmed at nonvolatile memory device 1400 under control of memory controller 1200. Afterwards, the method ends. If a copy of an LSB page is not required, the method proceeds to operation S310. In operation S310, data write requested by the host, that is, random write data may be programmed as LSB page data at nonvolatile memory device 1400 under control of memory controller 1200. Afterwards, the method ends.

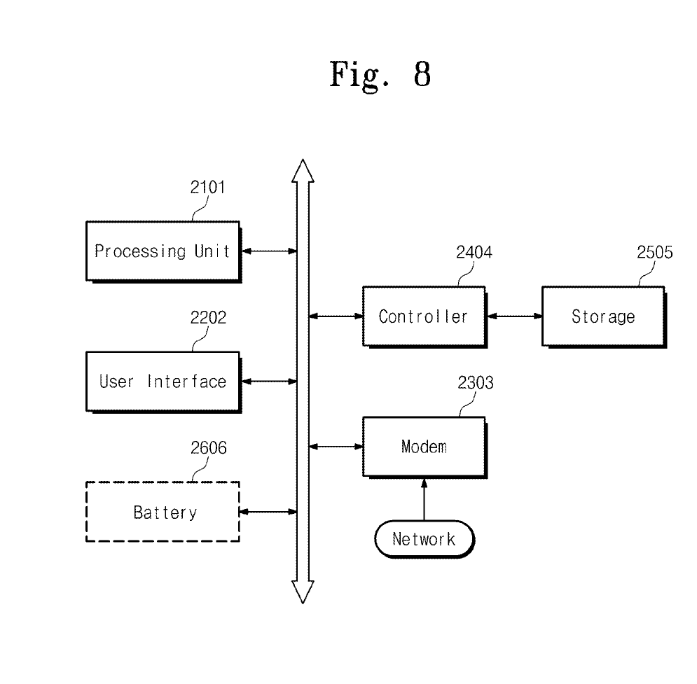

FIG. 8 is a block diagram illustrating a computing system according to an embodiment of the inventive concept.

Referring to FIG. 8, the computing system comprises a processing unit 2101, a user interface 2202, a modem 2303 such as a baseband chipset, a memory controller 2404, and storage medium 2505.

Memory controller 2404 is configured substantially the same as that described in FIG. 2, and storage medium 2505 may be formed of a nonvolatile memory device of FIG. 3. For example, memory controller 2404 may determine whether a write request of a host is a random write request or a sequential write request. Where the write request of a host is the sequential write request, memory controller 2404 controls the nonvolatile memory device such that data write requested by the host are sequentially programmed at LSB and MSB pages. In this case, the last page data may be copied to a separate storage space according to whether first page data of the write data affects the last page data previously written. Where the write request of a host is the random write request, memory controller 2404 controls the nonvolatile memory device such that restorable LSB page data is programmed prior to programming of data write requested by the host. That is, where the write request of a host is the random write request, memory controller 2404 controls the nonvolatile memory device such that restorable data is programmed in an LSB page and data write requested by the host is programmed in an MSB page.

N-bit data processed/to be processed by processing unit 2101 may be stored in storage medium 2505 through memory controller 2404. Where the computing system is a mobile device, a battery 2606 may be further included in the computing system to supply an operating voltage thereto. Although not illustrated in FIG. 8, the computing system may further comprise an application chipset, a camera image processor (CIS), a mobile DRAM, and the like.

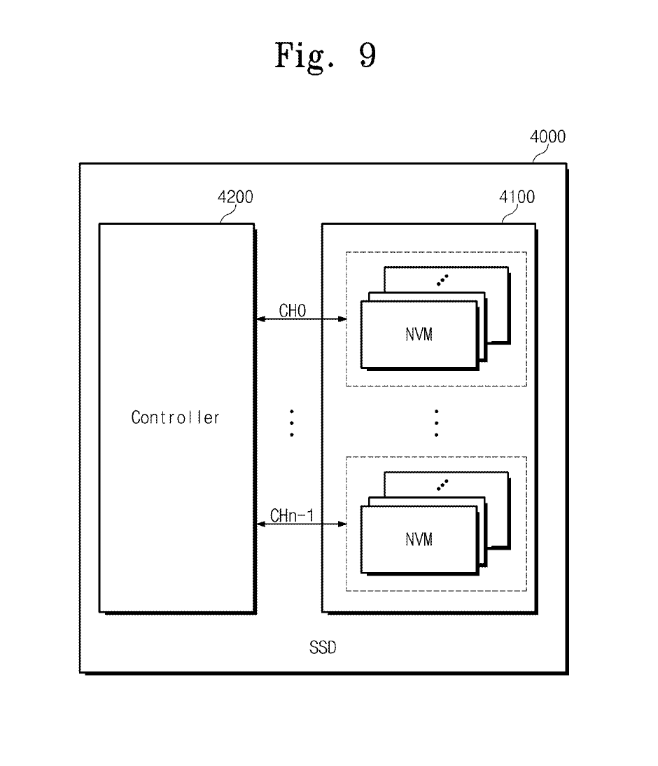

FIG. 9 is a block diagram illustrating an SSD according to an embodiment of the inventive concept.

Referring to FIG. 9, an SSD 4000 comprises storage medium 4100 and a controller 4200. Storage medium 4100 is connected with controller 4200 via multiple channels CH0 to CHn-1, each of which is commonly connected with multiple nonvolatile memories. Controller 4200 may be configured substantially the same as the controller described with reference to FIG. 2 or 3, and each of nonvolatile memory devices of storage medium 4100 may be formed of a nonvolatile memory device as described with reference to FIG. 5. Each of nonvolatile memory devices of storage medium 4100 may be configured to perform an impedance calibration operation.

Controller 4200 may be configured substantially the same as that described in FIG. 2, and each nonvolatile memory device in storage medium 4100 may be formed of a nonvolatile memory device of FIG. 3. For example, controller 4200 may determine whether a write request of a host is a random write request or a sequential write request. Where the write request of a host is the sequential write request, controller 4200 may control the nonvolatile memory device such that data write requested by the host are sequentially programmed at LSB and MSB pages. In this case, the last page data may be copied to a separate storage space according to whether first page data of the write data affects the last page data previously written. Where the write request of a host is a random write request, controller 4200 controls the nonvolatile memory device such that restorable LSB page data is programmed prior to programming of data write requested by the host. That is, where the write request of a host is the random write request, controller 4200 may control the nonvolatile memory device such that restorable data is programmed in an LSB page and data write requested by the host is programmed in an MSB page.

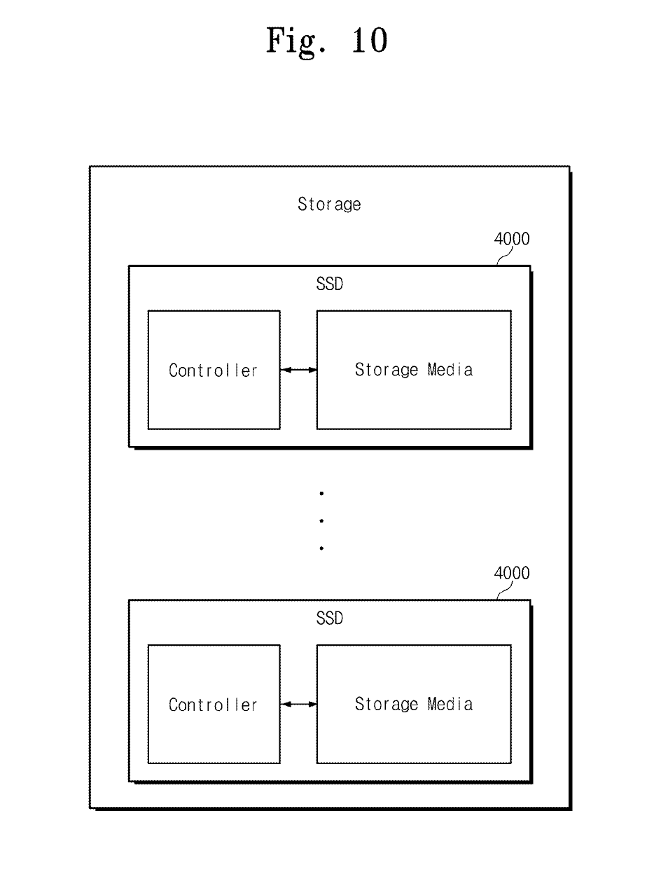

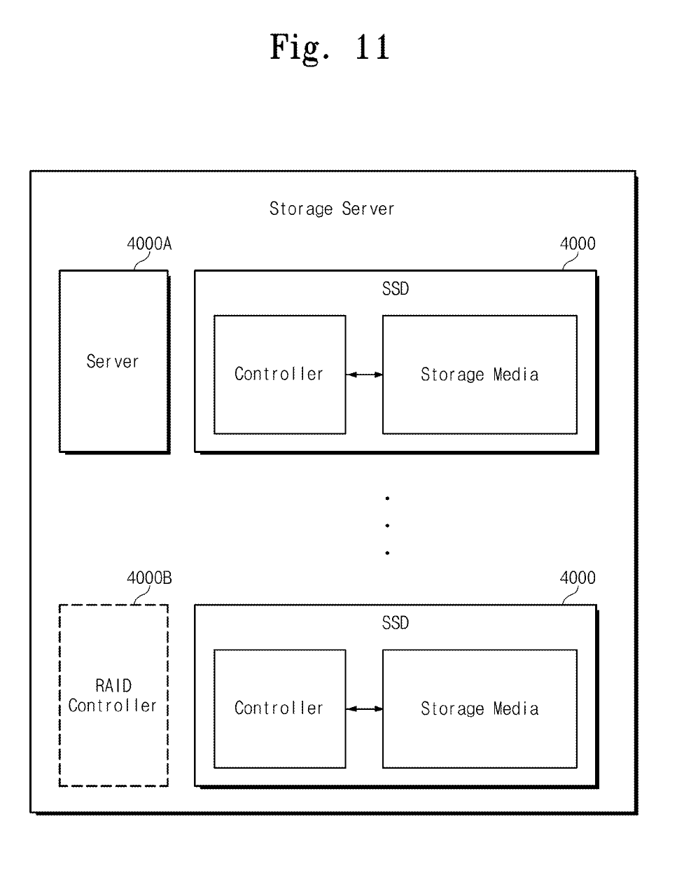

FIG. 10 is a block diagram illustrating a storage system comprising the SSD of FIG. 9 according to an embodiment of the inventive concept, and FIG. 11 is a block diagram illustrating a storage server comprising SSD 4000 of FIG. 9 according to an embodiment of the inventive concept.

Referring to FIG. 10, the storage system comprises multiple SSDs 4000 configured as described in FIG. 9. Referring to FIG. 11, the storage server comprises multiple SSDs 4000 configured as described in FIG. 9, and a server 4000A. Further, a RAID controller 4000B is also provided in the storage server.

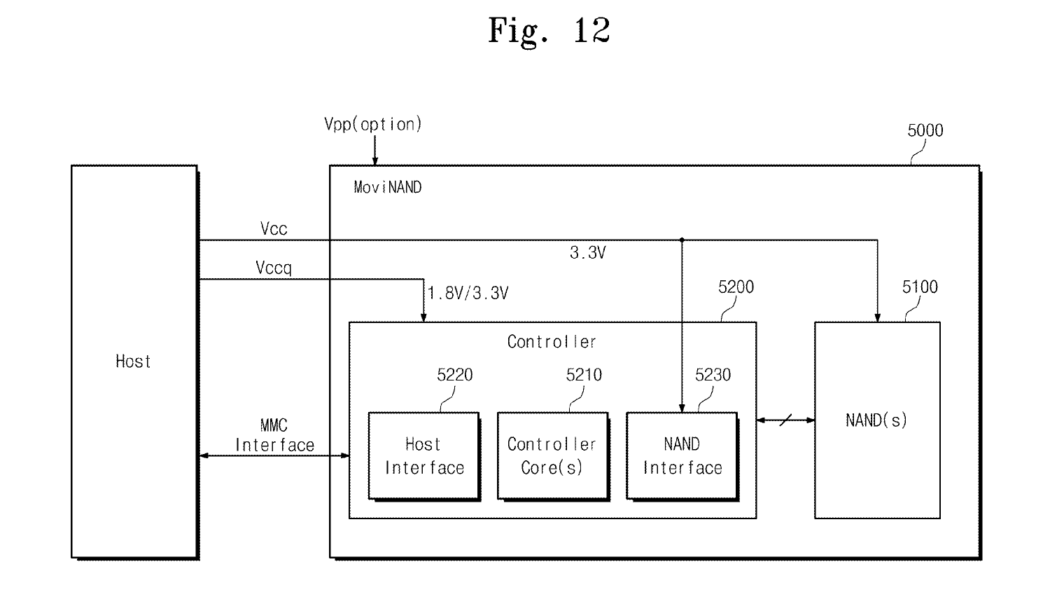

FIG. 12 is a block diagram illustrating a moviNAND according to an embodiment of the inventive concept.

Referring to FIG. 12, a moviNAND device 5000 comprises at least one NAND flash memory device 5100 and a controller 5200. MoviNAND device 5000 may support MMC 4.4 (or, referred to as “eMMC”) standard.

NAND flash memory device 5100 may be a single data rate (SDR) NAND flash memory device or a double data rate (DDR) NAND flash memory device. In some embodiments, NAND flash memory device 5100 comprises NAND flash memory chips. Herein, NAND flash memory device 5100 may be implemented by stacking the NAND flash memory chips at one package (e.g., FBGA, Fine-pitch Ball Grid Array, etc.).

Controller 5200 may be configured substantially the same as the controller described with reference to FIG. 2, and NAND flash memory device 5100 may be formed of a nonvolatile memory device of FIG. 3. For example, controller 5200 may determine whether a write request of a host is a random write request or a sequential write request. Where the write request of a host is the sequential write request, controller 5200 controls NAND flash memory device 5100 such that data write requested by the host are sequentially programmed in LSB and MSB pages. In this case, the last page data may be copied to a separate storage space according to whether first page data of the write data affects the last page data previously written. Where the write request of a host is a random write request, controller 5200 controls NAND flash memory device 5100 such that restorable LSB page data is programmed prior to programming of data write requested by the host. That is, where the write request of a host is the random write request, controller 5200 controls NAND flash memory device 5100 such that restorable data is programmed in an LSB page and data write requested by the host is programmed in an MSB page.

Controller 5200 is connected with NAND flash memory device 5100 via multiple channels. Controller 5200 comprises at least one controller core 5210, a host interface 5220, and a NAND interface 5230. Controller core 5210 controls overall operations of moviNAND device 5000. Host interface 5220 may be configured to perform an MMC interface between controller 5200 and a host. NAND interface 5230 may be configured to interface between NAND flash memory device 5100 and controller 5200. In some embodiments, host interface 5220 comprises a parallel interface (e.g., an MMC interface). In some other embodiments, host interface 5220 of moviNAND device 5000 comprises a serial interface (e.g., UHS-II, UFS, etc.).

MoviNAND device 5000 receives power supply voltages Vcc and Vccq from the host. Herein, power supply voltage Vcc (about 3.3V) may be supplied to NAND flash memory device 5100 and NAND interface 5230, while power supply voltage Vccq (about 1.8V/3.3V) may be supplied to controller 5200. In some embodiments, an external high voltage Vpp is optionally supplied to moviNAND device 5000.

MoviNAND device 5000 according to an embodiment of the inventive concept may be advantageous to store mass data as well as may have an improved read characteristic. MoviNAND device 5000 according to an embodiment of the inventive concept is applicable to small and low-power mobile products (e.g., a Galaxy S, iPhone, etc.).

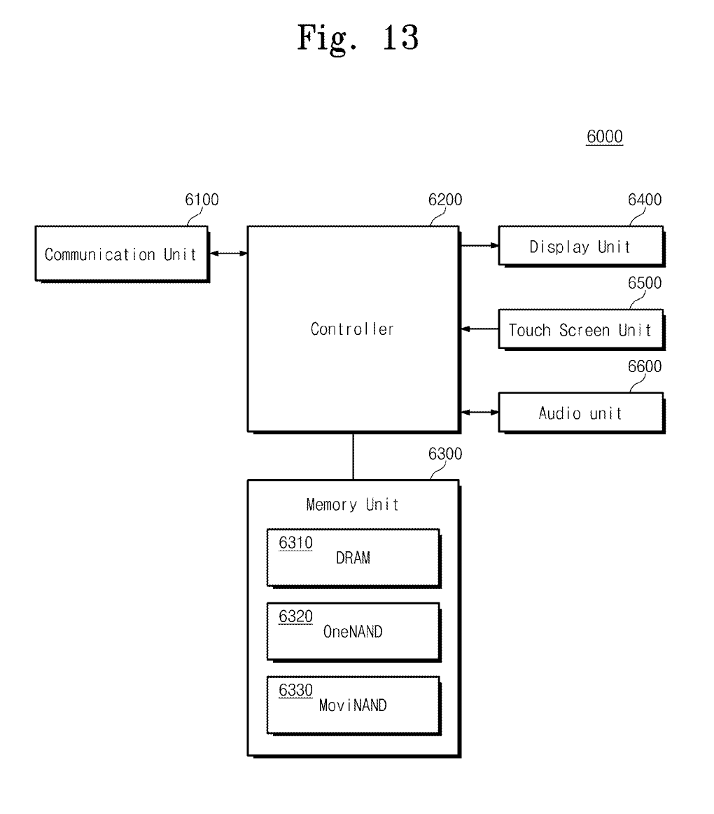

FIG. 13 is a block diagram illustrating a communication device according to an embodiment of the inventive concept.

Referring to FIG. 13, a communication device 6000 comprises a communication unit 6100, a controller 6200, a memory unit 6300, a display unit 6400, a touch screen unit 6500, and an audio unit 6600. Memory unit 6300 may comprise at least one DRAM 6310, at least one OneNAND 6320, and at least one moviNAND 6330. Examples of potentially applicable communication devices are disclosed in U.S. Patent Publications Nos. 2010/0010040, 2010/0062715, 2010/00199081, 2010/0309237 and 2010/0315325, the subject matter of which are hereby incorporated by reference.

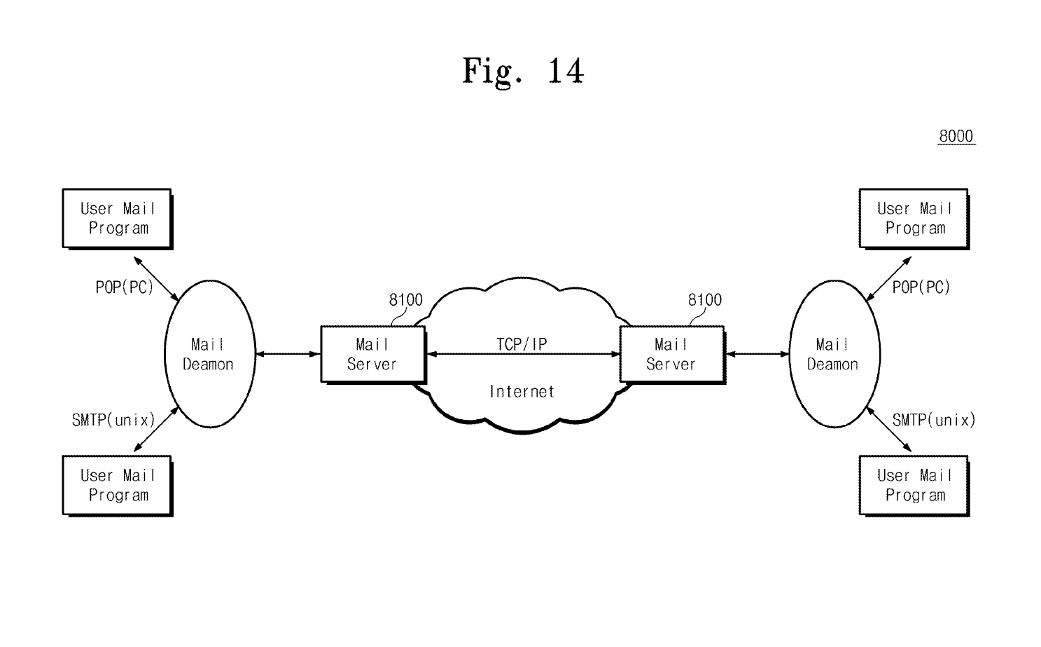

FIG. 14 is a diagram illustrating systems comprising a data storage device according to various embodiments of the inventive concept.

Referring to FIG. 14, an SSD comprising a data storage device according to an embodiment of the inventive concept may be applied to a main server 8100.

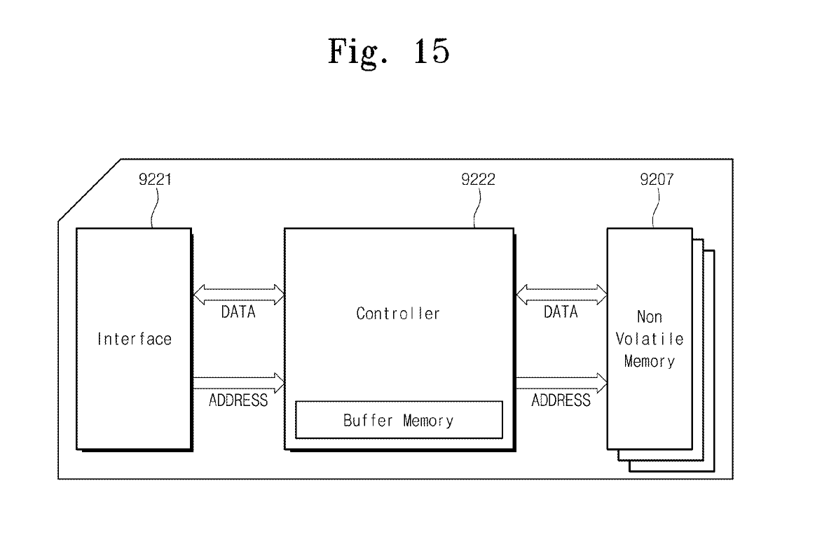

FIG. 15 is a block diagram illustrating a memory card according to an embodiment of the inventive concept. A memory card, for example, may be an MMC card, an SD card, a multiuse card, a micro-SD card, a memory stick, a compact SD card, an ID card, a PCMCIA card, an SSD card, a chip-card, a smartcard, an USB card, or the like.

Referring to FIG. 15, the memory card comprises an interface circuit 9221 for interfacing with an external device, a controller 9222 comprising a buffer memory and controlling an operation of the memory card, and at least one nonvolatile memory device 9207. Controller 9222 may be a processor which is configured to control write and read operations of nonvolatile memory device 9207. Controller 9222 is coupled with nonvolatile memory device 9207 and interface circuit 9221 via a data bus and an address bus. Interface circuit 9221 may interface with a host via a card protocol (e.g., SD/MMC) for data exchange between a host and a memory card.

Controller 9222 may be configured substantially the same as illustrated in FIG. 2, and nonvolatile memory device 9207 may be formed of a nonvolatile memory device illustrated in FIG. 3. For example, controller 9222 may determine whether a write request of a host is a random write request or a sequential write request. Where the write request of a host is the sequential write request, controller 9222 may control nonvolatile memory device 9207 such that data write requested by the host are sequentially programmed at LSB and MSB pages. In this case, a last page data may be copied to a separate storage space according to whether first page data of the write data affects the last page data previously written. Where the write request of a host is the random write request, controller 9222 may control nonvolatile memory device 9207 such that restorable LSB page data is programmed prior to programing of data write requested by the host. That is, where the write request of a host is the random write request, controller 9222 may control nonvolatile memory device 9207 such that restorable data is programmed in an LSB page and data write requested by the host is programmed in an MSB page.

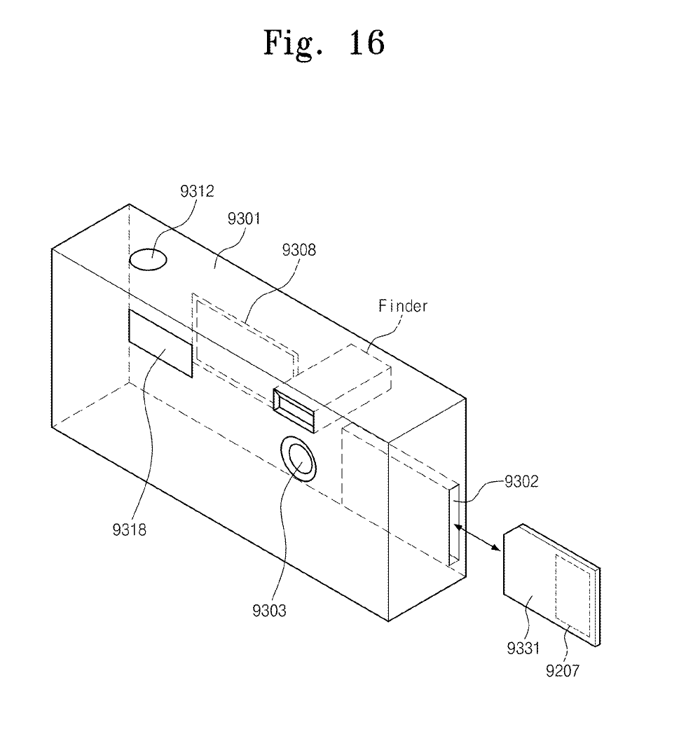

FIG. 16 is a block diagram illustrating a digital camera according to an embodiment of the inventive concept.

Referring to FIG. 16, a digital camera comprises a body 9301, a slot 9302, a lens 9303, a display circuit 9308, a shutter button 9312, a strobe 9318, and the like. Memory card 9331 comprises a memory controller and a nonvolatile memory device described in FIG. 1.

The memory controller may be configured substantially the same as illustrated in FIG. 2, and the nonvolatile memory device may be formed of a nonvolatile memory device illustrated in FIG. 3. For example, the memory controller may determine whether a write request of a host is a random write request or a sequential write request. Where the write request of a host is the sequential write request, the memory controller may control the nonvolatile memory device such that data write requested by the host are sequentially programmed at LSB and MSB pages. In this case, the last page data may be copied to a separate storage space according to whether first page data of the write data affects the last page data previously written. Where the write request of a host is the random write request, the memory controller may control the nonvolatile memory device such that restorable LSB page data is programmed prior to programing of data write requested by the host. That is, where the write request of a host is the random write request, the memory controller may control the nonvolatile memory device such that restorable data is programmed in an LSB page and data write requested by the host is programmed in an MSB page.

If memory card 9331 has a contact type, an electric circuit on a circuit board may be electrically contacted with memory card 9331 where it is inserted in slot 9302. Where memory card 9331 has a non-contact type, an electric circuit on a circuit board may communicate with memory card 9331 in a radio-frequency manner.

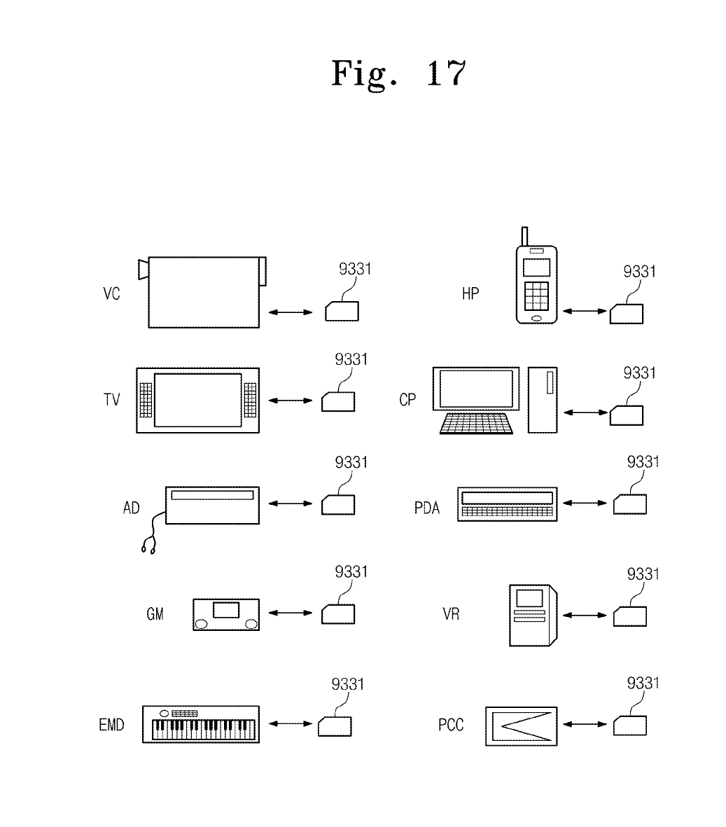

FIG. 17 is a diagram illustrating various systems comprising the memory card of FIG. 15 according to embodiments of the inventive concept.

Referring to FIG. 17, memory card 9331 may be applied to a video camera VC, a television TV, an audio device AD, a game machine GM, an electronic music device EMD, a cellular phone HP, a computer CP, a Personal Digital Assistant (PDA), a voice recorder VR, a PC card PCC, and the like.

In example embodiment, memory cells can be formed of a variable resistance memory cell. An example of a variable resistance memory cell and a memory device comprising the same are disclosed in U.S. Pat. No. 7,529,124, the subject matter of which is hereby incorporated by reference.

In other example embodiments, memory cells can be formed of one of various cell structures having a charge storage layer. Cell structures having a charge storage layer comprise a charge trap flash structure using a charge trap layer, a stack flash structure in which arrays are stacked at multiple layers, a source-drain free flash structure, a pin-type flash structure, and the like. An example memory device having a charge trap flash structure as a charge storage layer is disclosed in U.S. Pat. No. 6,858,906 and U.S. Patent Publication Nos. 2004/0169238 and 2006/0180851, the subject of which is hereby incorporated by reference. A source-drain free flash structure is disclosed in KR Patent No. 673020, the subject matter of which is hereby incorporated by reference.

A flash memory device and/or a memory controller according to various embodiments of the inventive concept may be packed using various types of packages. For example, A nonvolatile memory device or a memory controller according to an embodiment of the inventive concept may be packed using packages such as Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The foregoing is illustrative of embodiments and is not to be construed as limiting thereof. Although a few embodiments have been described, those skilled in the art will readily appreciate that many modifications are possible in the embodiments without departing from the scope of the inventive concept as defined in the claims.

What is claimed is:

1. A method of operating a memory system comprising a nonvolatile memory device, comprising:
determining whether a write request from a host is a random write request; and
as a consequence of determining that the write request is a random write request, programming a lower page of a selected word line of the nonvolatile memory device with restorable data of the nonvolatile memory device, and programming an upper page of the selected word line with write data corresponding to the write request after programming the lower page.

2. The method of claim 1, wherein the restorable data is valid data stored in a memory block that is a garbage collection target.

3. The method of claim 2, further comprising erasing the memory block that is the garbage collection target after write data corresponding to the last valid data is normally programmed.

4. The method of claim 1, wherein the restorable data is metadata of a memory controller.

5. The method of claim 2, further comprising determining that a power loss occurred while upper page data is programmed with the write data, and as a consequence of determining that the power loss occurred, restoring data of a lower page corresponding to the upper page from the memory block that is the garbage collection target.

6. The method of claim 1, further comprising:
as a consequence of determining that the write request is not a random write request, determining whether the write data corresponding to the write request accompanies a lower page backup operation;
as a consequence of determining that the write data corresponding to the write request of the host accompanies the lower page backup operation, backing up a lower page of a storage space where first page data of the write data is to be programmed, and sequentially programming the write data.

7. The method of claim 6, further comprising:
as a consequence of determining that the write data corresponding to the write request of the host is not to accompany the lower page backup operation, sequentially programming the write data in the nonvolatile memory device.

8. The method of claim 1, further comprising as a consequence of determining that the write request of the host is a random write request, determining whether a memory block that is a garbage collection target exists.

9. The method of claim 8, further comprising:
as a consequence of determining that a memory block that is a garbage collection target does not exist, determining whether the write data corresponding to the write request of the host accompanies a lower page backup operation;
as a consequence of determining that the write data corresponding to the write request of the host accompanies the lower page backup operation, backing up a lower page of a storage space where first page data of the write data is to be programmed, and sequentially programming the write data.

10. The method of claim 1, further comprising:
as a consequence of determining that the write data corresponding to the write request of the host is not to accompany the lower page backup operation, programming the write data.

11. A memory system, comprising:
a nonvolatile memory device comprising multiple memory blocks; and
a memory controller configured to control the nonvolatile memory device, wherein the controller is configured to receive a write request from a host, determine whether the write request is a random write request, and as a consequence of determining that the write request is a random write request, programming a lower page of a selected word line of the nonvolatile memory device with restorable data of the nonvolatile memory device, and programming an upper page of the selected word line with write data corresponding to the write request after programming the lower page.

12. The memory system of claim 11, wherein the restorable data is valid data stored in a memory block that is a garbage collection target.

13. The memory system of claim 11, wherein where the host write request is a random write request, the memory controller determines whether a memory block that is a garbage collection target exists.

14. The memory system of claim 13, wherein where the memory block that is a garbage collection target exists, the memory controller controls the nonvolatile memory device such that restorable data is programmed at the lower page and such that write data corresponding to the host write request is programmed as upper page data in the upper page.

15. The memory system of claim 13, wherein where a memory block being a garbage collection target does not exist, the memory controller controls the nonvolatile memory device such that the write data is programmed after a lower page of a storage space where the write data is to be programmed is backed up or such that the write data is programmed without a lower page backup operation, according to whether the write data corresponding to the host write request accompanies the lower page backup operation.

16. A method of operating a memory system comprising a nonvolatile memory device, comprising:
storing a first unit of data at a first location in the nonvolatile memory device, and thereafter receiving a write request to program a second unit of data at a second location in the nonvolatile memory device;
determining whether the write request is a sequential write request; and
as a consequence of determining that the write request is not a sequential write request, programming the first unit of data in a lower page of the second location without erasing the first unit of data from the first location, and initiating programming of the second unit of data in an upper page of the second location.

17. The method of claim 16, further comprising:
detecting interruption of the programming of the second unit of data; and
as a consequence of detecting the interruption, reprogramming the first unit of data from the first location to the lower page of the second location.

18. The method of claim 17, wherein the interruption is produced by a power loss or program failure of the nonvolatile memory device.

19. The method of claim 16, wherein the first unit of data comprises a valid unit of data in a memory block designated for garbage collection.

20. The method of claim 16, wherein the first unit of data comprises metadata.
